(19) United States
(12) Patent Application Publication
(10) Pub. No.: US 2009/0327875 A1
(43) Pub. Date: Dec. 31, 2009

(54) DESIGN EDITING APPARATUS, DESIGN EDITING METHOD, AND STORAGE MEDIUM STORING DESIGN EDITING PROGRAM

(75) Inventor: TOSHIKAZ KINKOH, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/489,880

(22) Filed: Jun. 23, 2009

(30) Foreign Application Priority Data
Jun. 26, 2008 (JP) 2008-167860

(51) Int. Cl. G06F 17/00

(52) U.S. Cl. 715/255

(57) ABSTRACT

A design editing apparatus capable of editing designs includes a display unit that displays an editing screen for editing designs, an operation unit through which operations input by a user are received, an input unit that inputs characters or images based on the user operations input via the operation unit, a storage unit that stores therein templates describing a file structure for generating basic designs and derived designs regarding the basic designs, and a design generation unit that generates basic designs using the templates stored in the storage unit and the characters or images input from the input unit to be displayed on the display unit, and generates a derived design regarding the basic design selected by the user via the operation unit from the displayed basic designs using the templates stored in the storage unit and the characters or images input from the input unit to be displayed on the display unit, thereby displaying the derived design selected by the user via the operation unit on the editing screen.

### BACKGROUND OF THE INVENTION

1. Field of the Invention

The present invention relates to a design editing apparatus for editing text data or image data stored in a storage device. More specifically, the present invention relates to a design editing apparatus having the function of automatically generating designs.

2. Description of the Related Art

Up to now, various types of application software have been released, which are executed on a personal computer to produce page designs of posters, catalogues, presentation data, postcards, leaflets, advertisements or the like.

A well-known desktop publishing (DTP) function is installed in the software for producing page designs. The software for producing page designs is also referred to as a page design application. The page design application is capable of editing the layout of page design elements such as images, characters or cliparts. In addition, the page design application is equipped with a printing function of printing out data with a large-format printer as well as a shadow-casting function of shadowing images or characters and a function of applying various types of decorative effects.

Known page design applications can be classified into two types: expensive and advanced applications designed for professional graphic designers and relatively inexpensive and general-purpose applications featuring simple operation and processing.

The applications designed for professional graphic designers place more emphasis on the range of functions than the user-friendliness so that the intentions of the graphic designers (users) are reflected as accurate and as much as possible. Thus, such applications are too difficult for general users to master because a long period of time must be spent in learning them.

On the other hand, the general-purpose applications are intended for users who have some degree of knowledge on operating office applications on a personal computer, such as an operating system (OS), a word processor, or a spreadsheet. Therefore, some application products simplify the operations from the production of page designs to the printing of the page designs, and guide users along the design production flow up to the print setting step as well as the editing operations.

Most of the general-purpose applications provide elements enabling users to effectively produce page designs such as design templates (forms), clip arts, or photos, which are designed in advance by graphic designers, in order for the users to produce high-quality page designs with a simple operation. Then, the users follow the procedure of selecting a design template that matches the final image of an intended page design and then completing the page design with additional editing as appropriate, such as replacement of photos, text editing, addition of other elements, or application of decorative effects.

For general users who do not have adequate knowledge about layout designs and color designs, a lot of time may be required to produce a desired page design from a blank state, and accordingly, the completed one cannot be said desirable in terms of design. Here, “the page design that is desirable in terms of design” means a page design of which the message or intent is correctly delivered to the readers or viewers of the designed page, a page design that is easy to read, and possibly a page design that gives a strong impression to the readers or viewers of the designed page. To produce such a page design, users need to have basic knowledge and know-how about design, such as a layout or coloration.

Some of the recent page design production applications not only provide the procedures for selecting existing design templates, but also provide the procedures for designating design image which is the impression that the designed page gives to the readers or the viewers, thereby generating variations in the layout or coloration of the page design. Moreover, a technique is known that allows users to select an appropriate one that matches the desired image from the generated variations.

The invention disclosed in Japanese Patent Application Laid-Open No. H07-306935, for example, describes an apparatus that includes a database storing therein coloration images, thereby allowing users to easily select a coloration image of the final page design so that the produced page design can give the impression intended by the users.

The invention disclosed in Japanese Patent Application Laid-Open No. H09-146948, for example, describes an apparatus that determines a page layout based on the arrangement of page design elements desired by the users. The apparatus includes a layout unit that stores restrictions on the arrangement of the page design elements and arranges the page design elements in an arrangement area designated by the user based on the restrictions. Therefore, the page design elements that are newly generated and inserted can be appropriately arranged.

The invention disclosed in Japanese Patent Application Laid-Open No. H11-232474, for example, describes an apparatus that combines a design template complying with the page design requirements input from users with page design elements designated by the users, thereby producing a page design.

In recent years, application software that automatically generates a page design based on page elements, purposes, and requirements designated by users has been released. This application provides a means for automatically generating several hundreds of page designs in response to the input regarding images, clipart, texts, or page orientation to be used on the page design, thereby allowing users to select an appropriate one from the generated page designs.

This application displays the automatically generated page designs in a thumbnail view on a two-dimensional coordinate where the presence of a background image is displayed on the horizontal axis, and the size of a main subject is displayed on the vertical axis. Such a display method helps users in selecting the design desired by the users. In addition, the users can select a thumbnail image displayed on the two-dimensional coordinate and select a coloration image for the page design, which represents the impression of the page design.

For selection of the coloration image, a color palette and a plurality of combinations (color variations) using the colors on the color palette are defined for each of the coloration images. Therefore, the users select a coloration image and a color variation that belongs to the selected coloration image. These techniques comprehensively support the users' page design production works.

As described above, the known editing applications that automatically present page design candidates to users are useful because the applications can present the general users with insufficient knowledge on design with the page designs reflecting various design know-hows.

However, one problem of the known applications is that if too many design candidates are displayed in a list form to be presented to users, then, the users have to scroll through a number of screen pages, and hence, the viewability on the display screen is impaired.

Another problem of the known applications is that the more the number of design candidates in the list are presented to the users, the more it becomes difficult for the users to make the best choice on the design; on the other hand, the less the number of design candidates are presented, the less the number of choices the users can select from will become.

### SUMMARY OF THE INVENTION

An object of the present invention is to provide a design editing apparatus capable of allowing users to be provided with larger room for choice on designs without difficulty, without decreasing the number of choices the users can select from and without impairing the viewability on a display screen, even when a number of design candidates are presented to the users.

According to an aspect of the present invention, there is provided a design editing apparatus capable of editing designs.

The design editing apparatus includes a display unit that displays an editing screen for editing designs; an operation unit through which operations input by a user are received; an input unit that inputs characters or images based on the user operations input via the operation unit; a storage unit that stores therein templates describing a file structure for generating basic designs and derived designs regarding the basic designs; and a design generation unit that generates basic designs using the templates stored in the storage unit and the characters or images input from the input unit to be displayed on the display unit, and generates a derived design regarding the basic design selected by the user via the operation unit from the displayed basic designs using the templates stored in the storage unit and the characters or images input from the input unit to be displayed on the display unit, thereby displaying the derived design selected by the user via the operation unit on the editing screen.

According to another aspect of the present invention, there is provided a design editing method for editing designs.

The design editing method includes the steps of: displaying an editing screen for editing designs; receiving operations input by a user; inputting characters or images based on the user's operations; generating and displaying basic designs using templates extracted from a template database, the templates being created and stored in advance and capable of describing a file structure for generating basic design and derived designs regarding the basic designs, and the characters or images input in the inputting step, and generating and displaying a derived design regarding the basic design selected by the user in the receiving step from the displayed basic designs using the templates and the characters or images input in the inputting step, thereby displaying the derived design selected by the user in the receiving step on the editing screen.

According to a further aspect of the present invention, there is provided a storage medium storing therein a design editing program for editing designs.

The program causes a computer to execute the steps of: displaying an editing screen for editing designs; receiving operations input by a user; inputting characters or images based on the user's operations; generating and displaying basic designs using templates extracted from a template database, the templates being created and stored in advance and capable of describing a file structure for generating basic design and derived designs regarding the basic designs, and the characters or images input in the inputting step, and generating and displaying a derived design regarding the basic design selected by the user in the receiving step from the displayed basic designs using the templates and the characters or images input in the inputting step, thereby displaying the derived design selected by the user in the receiving step on the editing screen.

Further features of the present invention will become apparent from the following description of exemplary embodiments with reference to the attached drawings.

### BRIEF DESCRIPTION OF THE DRAWINGS

FIG. 1 illustrates a main screen 10 of a page design application.

FIG. 2 illustrates a basic layout design group generation screen 20.

FIG. 3 illustrates a basic layout design group display screen 30.

FIG. 4 illustrates a fine adjustment layout design display screen 40.

FIG. 5 illustrates a processing flow for displaying the basic layout design group display screen 30 according to a user's input.

FIG. 6 illustrates a file structure 50 of a basic layout design selected in step S8.

FIG. 7 illustrates a processing flow when Fine-Adjust button 33 in FIG. 3 is pressed for the basic layout design selected by the user.

FIG. 8 is a block diagram illustrating a configuration of an apparatus for executing the page design application according to an exemplary embodiment of the present invention.

### DESCRIPTION OF THE EMBODIMENTS

Exemplary embodiments of the present invention will now be described.

### First Exemplary Embodiment

Description of a function of automatic generation of page design variations will be described.

The automatic generation function of page design variations is implemented as a part of application software which is executed on a personal computer to produce or edit page designs. In the following description, this software will be referred to as a page design application. In some cases, this software is simply referred to as an application. The page design is an object to be edited by the application, and it includes a general office document and a document intended for specific purpose, such as a poster, a postcard, or presentation data. The page design is produced by arranging various objects in a layout, the objects including raster data such as JPEG files of photos or images, vector data drawn by a figure drawing function, and text data which is character information.

The page design application has various functions for editing page designs. Examples of the page design editing functions include resizing, moving, and rotating of page elements, image correction, text editing, decorative processing on photos or texts, and background setting. Processing for drawing a frame border or making a shadow will be generally referred to as the decorative processing.

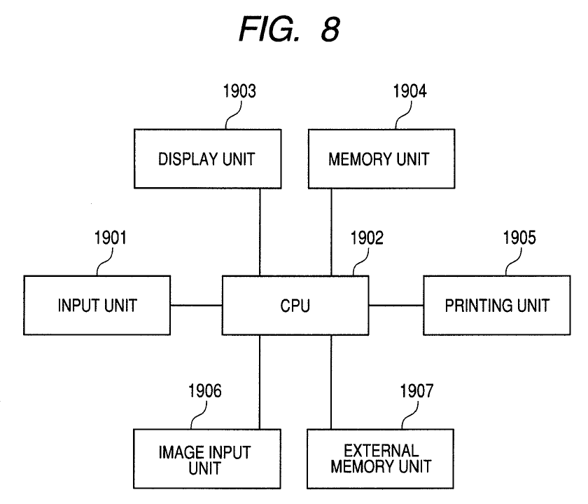

FIG. 8 is a block diagram illustrating a configuration of an apparatus (a personal computer) for executing the page design application according to an exemplary embodiment of the present invention. In this exemplary embodiment, the page design in a poster or a written material (also called documents) are produced or edited in such a manner that, when a user operates the personal computer on which the page design application is executed, the user's operations are input to the page design application, whereby the page design is produced or edited.

In FIG. 8, the apparatus includes an input unit (or device) 1901, such as a keyboard, a mouse, a pen input device, or a touch panel, a central processing unit (CPU) 1902 configured to manage and control the system, input and correct images and generate editing data for printing, and a display unit (display) 1903 to be used for display. The apparatus further includes a memory (or storage) unit 1904, such as a hard disk, configured to store the image data files or corresponding image correction command history files, a printing unit 1905 configured to output the edited data, an image input unit 1906, such as a film scanner, a flat-bed scanner, or a digital camera, and an external memory (or storage) unit 1907, such as a floppy (the registered trademark) disk drive or a storage medium for use with a digital camera. The printing unit 1905 is a printer connected to a local interface such as a USB or a network such as a LAN. The printer may be any one of ink jet printers, electrophotographic printers, and offset printing machines. Moreover, the printer may be a printer configured to print images on cut sheet paper such as A4-size normal paper or postcards or a large-format printer configured to print images on large-format roll sheet paper such as A0-size roll paper.

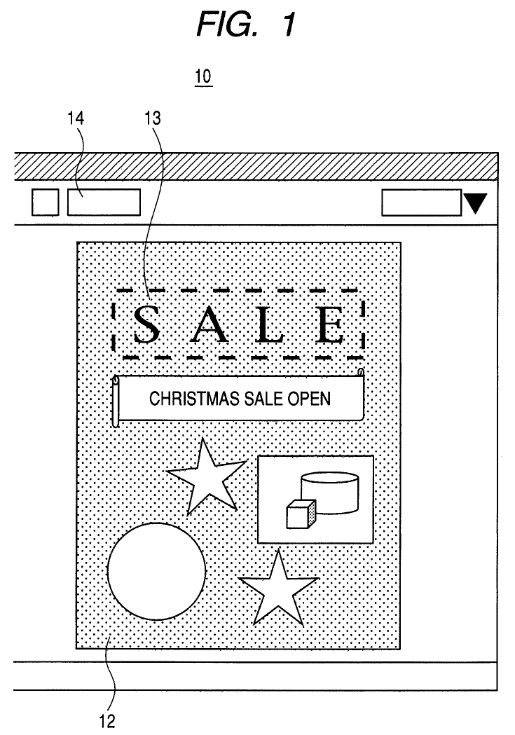

The page design application program is stored in the storage unit 1904 and is read and executed by the CPU 1902. The CPU 1902 executes the page design application program, thereby displaying a main screen 10 shown in FIG. 1 on the display unit 1903 and producing or editing page designs based on the user's operations on the input unit 1901 to be displayed on the main screen 10. In the following description, the displaying executed by the application means displaying a display screen or designs on the display unit shown in FIG. 1. The page designs displayed on the main screen 10 may be printed using the printing unit 1905 by non-illustrated operations.

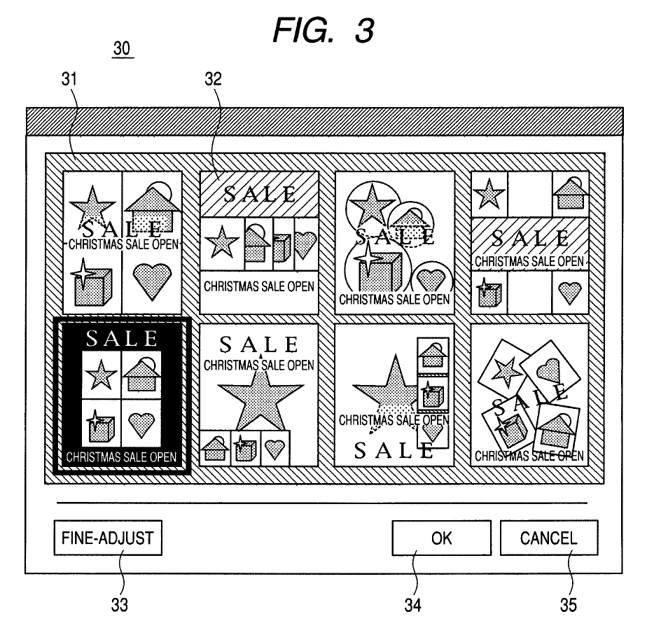

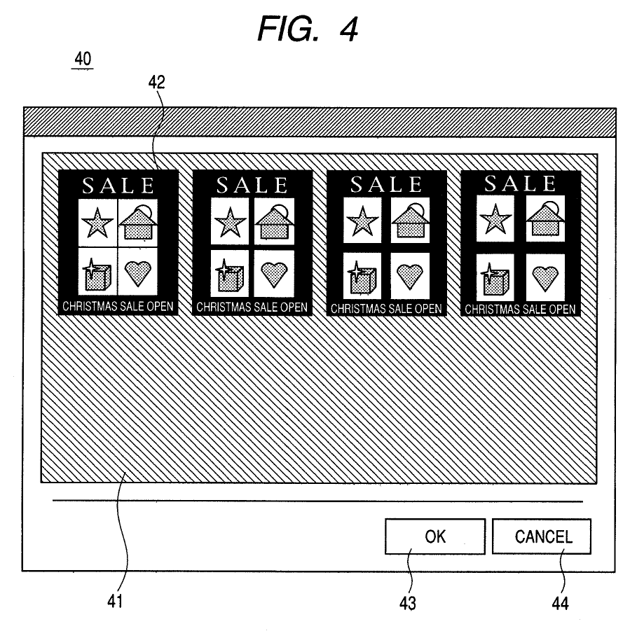

The main screen 10 shown in FIG. 1 includes a preview area 12 for displaying designs. The designs may be displayed on the preview area 12 by the following methods. (1) When characters or images created by graphic designers are input and a user selects any one of a plurality of design templates provided by the application, the selected design template is displayed on the preview area 12. (2) When a user produces a new page design, the new page design is displayed on the preview area 12. (3) When a user conducts an operation for opening the file of a page design which is created and stored in advance and is different from the template provided by the application, the page design file stored in the external storage unit 1907 is read out into the storage unit 1904, and the read-out data are developed by the application to be displayed on the preview area 12. (4) A basic layout design which is automatically produced by the application using characters or images input by a user and is displayed on a later-described basic layout design display screen shown in FIG. 3 and a fine-adjustment layout design which is automatically produced by the application and is displayed on a later-described fine-adjustment layout design display screen shown in FIG. 4 are displayed on the preview area 12. In this exemplary embodiment, those persons who are capable of providing higher quality designs than the designs produced by the general users will be generally referred to as the graphic designers. Therefore, the scope of the graphic designers in this exemplary embodiment includes not only the professional graphic designers, but also all the persons capable of providing high quality designs usable as the design template of the application.

In FIG. 1, an object is surrounded by a frame line 13, which means that the object is selected by the user's operation in the page design on display, specifically, a text object “SALE” is selected by the user. A later-described basic layout variation generation button 14 is also displayed on the main screen 10.

Although not shown in FIG. 1, the main screen 10 further includes a screen for displaying, in a list form, menus or toolbars corresponding to various processing, buttons, and the design elements such as photos, clipart, photo frames, character decorations, backgrounds, etc. These design elements will be generally referred to as “artworks.”

The preview area 12 is an area for displaying the selected page designs within the document to be edited. In the preview area 12, objects which are the elements on the page design can be moved or resized. Although in FIG. 1, the entire page design that is being edited is displayed in the preview area 12, only a part of the page design may be displayed by changing the display scaling.

The user's operations are input to the page design application by entering commands using an input device, such as a mouse or keyboard connected to the personal computer.

In the first exemplary embodiment, although a document comprised of one page is edited, a document comprised of plural pages may be edited. In this case, the application provides a page move command for allowing users to go to any page so that a user can move to a page designated by the user. In addition, the application may have a function of supporting an editing process, such as a guide, a grid, or ruler, so that objects can be correctly arranged at the intended positions.

Although FIG. 1 illustrates the state where the text object “SALE” 13 on the page design is selected, the user can select another desired object by the mouse clicking operation or the keyboard operation using a TAB key.

The basic layout variation generation button 14 is located on the toolbar. Although not shown in FIG. 1, the toolbar includes another processing button and a dropdown list for designating the display scaling of the preview area 12.

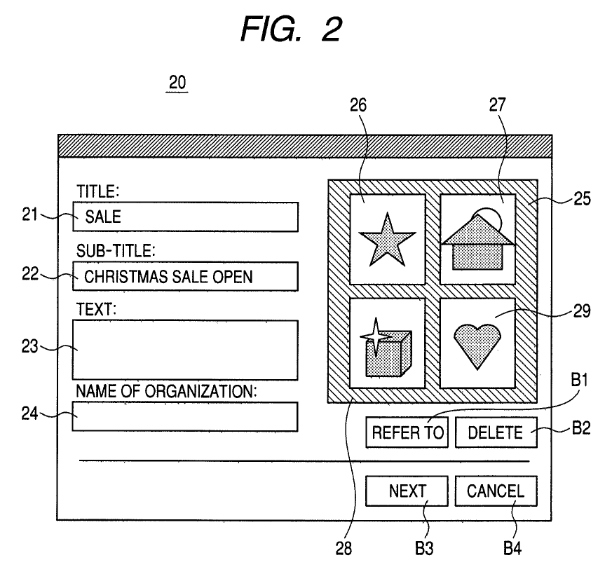

FIG. 2 illustrates a basic layout design group generation screen 20.

The page design application displays the basic layout design group generation screen 20 in response to detecting the clicking (pressing) of the basic layout variation generation button 14 shown in FIG. 1 by the user's operation of the mouse or the keyboard connected to the personal computer.

The basic layout design group generation screen 20 is a screen for generating a group of basic layout designs. On the basic layout design group generation screen 20, a title input area 21, a subtitle input area 22, a text input area 23, and an organization name input area 24. On the basic layout design group generation screen 20, a user image input area 25 is also displayed. The user image input area 25 is an area for entering images selected by the user to be used in the design production. In FIG. 2, first to fourth user input images 26 to 29 are entered on the user image input area 25. On the basic layout design group generation screen 20, Refer-To button B1, Delete button B2, Next button B3, and Cancel button B4 are displayed.

The basic layout design group generation screen 20 shown in FIG. 2 is a screen generated when the type of a document to be produced is a poster, on which, when necessary information is entered, a group of basic layout designs is generated and displayed on a next screen.

On the basic layout design group generation screen 20, the user enters a title, a subtitle, a text, and an organization name to be used in the poster, as necessary, into the title input area 21, the subtitle input area 22, the text input area 23, and the organization name input area 24, respectively. Moreover, images to be used in the poster are entered into the user image input area 25. The images are entered into the user image input area 25 by drag-and-dropping, with the mouse, files on a file system of the personal computer. Alternatively, the images may be entered into the user image input area 25 by pressing the Refer-To button B1 and selecting desired images on a non-illustrated typical file input dialog box. Alternatively, images to be entered may be selected from images stored on another computer accessible via a network by performing similar operations.

On the user image input area 25, the thumbnail images of the first to fourth user input images 26 to 29 which have been entered are displayed.

The images in the user image input area 25 are arranged according to priority, i.e., from top to bottom and from left to right. The user can change the arrangement order by drag-and-dropping, with the mouse, the thumbnails of the images entered into the user image input area 25. Moreover, the user can delete unnecessary images by selecting them and then pressing the Delete button B2.

The user presses the Next button B3 when all the necessary information has been entered into the character information input areas 21 to 24 and the user image input area 25, thereby instructing the page design application to produce a group of basic layout designs.

The user may return to the main screen 10 of the application by pressing the Cancel button B4 at any point in time; in this case, the entered information on the user image input area 25 is cancelled.

FIG. 3 illustrates a basic layout design group display screen 30. The layout design group means a plurality of page designs automatically produced by the page design application. The automatically produced page designs will be referred to as layout designs or basic layout designs.

The basic layout design group display screen 30 is a screen that is generated and displayed by the application when the user presses the Next button 53 in the state shown in FIG. 2. The basic layout design group display screen 30 includes a basic layout design display area 31, basic layout design thumbnails 32, a Fine-Adjust button 33, an OK button 34 and a Cancel button 35.

The basic layout design group display screen 30 is a screen for displaying a group of basic layout designs generated by the application based on the character information and the image information entered by the user on the screen shown in FIG. 2. The generated layout designs are displayed in the basic layout design display area 31. In this case, thumbnails of the basic layout designs are created and displayed as the basic layout design thumbnails 32 in FIG. 3.

The user can select a desired layout design from a group of displayed basic layout design thumbnails via the input unit such as the mouse. When the user selects one of the basic layout designs displayed on the basic layout design display screen 30 and presses the OK button 34, the application displays the selected basic layout design in the preview area 12 of the main screen 10 upon detecting the pressing of the OK button. At this time, the page design displayed in the preview area 12 before the basic layout designs are produced is replaced with the selected basic layout design.

When the user selects one of the displayed basic layout design thumbnails and presses the Fine-Adjust button 33, the application generates variations reflecting fine adjustment on the selected basic layout design and the generated variations are displayed on a fine-adjustment layout design display screen 40 shown in FIG. 4.

FIG. 4 illustrates the fine-adjustment layout design display screen 40. The fine-adjustment layout designs are derived designs that are produced from the basic layout design, in which the arrangement or the size of objects is slightly changed within the range that dose not greatly change the impression to the viewers. As for the fine-adjustment layout designs, the objects that can be changed by the designer and the adjustment range are determined in advance.

FIG. 4 illustrates an example of the fine-adjustment layout design display screen 40 when the Fine-Adjust button 33 is pressed in the state where the design at the left-bottom corner is selected on the basic layout design group display screen 30.

The fine-adjustment layout design display screen 40 includes a fine-adjustment layout design display area 41, on which fine-adjustment layout design candidate thumbnails 42 are displayed. On the fine-adjustment layout design display screen 40, an OK button 43 and a Cancel button 44 are further displayed. The fine-adjustment layout design candidate thumbnails 42 are the thumbnails of fine-adjustment layout designs which are produced from the basic layout design by changing the arrangement or the size of the objects within a predetermined adjustment range.

FIG. 4 illustrates an example in which four designs are displayed in the fine-adjustment layout design display area 41 as the fine-adjustment layout designs of the selected basic layout design. In these four designs, the distance between four image objects arranged at the center of each design is gradually increased.

When the user presses the Cancel button 44 on the fine-adjustment layout design display screen 40 in FIG. 4, the user can return to the basic layout design group display screen 30 shown in FIG. 3. When it is detected that the user presses the OK button 43 in the state where one of the fine-adjustment layout design thumbnails displayed on the fine-adjustment layout design display screen 40 shown in FIG. 4 is selected by the user's operation, the application displays the selected design on the main screen 10 in response to the pressing. At this time, the page design displayed on the main screen 10 before the fine-adjustment layout designs are produced is replaced with the newly selected fine-adjustment layout design.

Next, the processing flow for displaying the basic layout design group display screen 30 according to the user's input operations will be described.

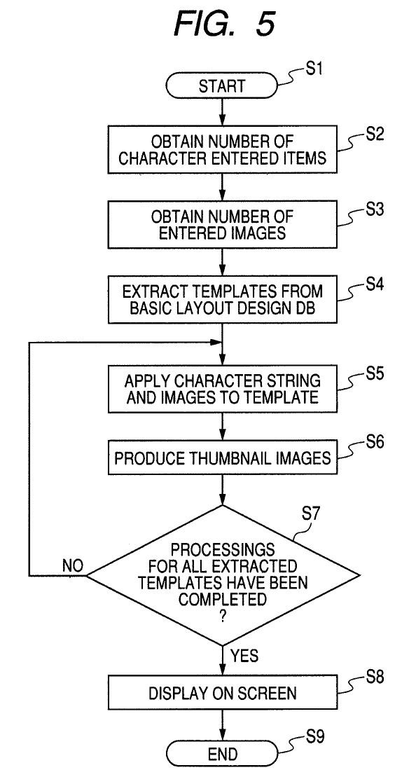

FIG. 5 illustrates the processing flow in the application for displaying the basic layout design group display screen 30 according to the user's input operations.

In step S1, a process of producing basic layout design candidates is started. This process corresponds to a case where the user presses the Next button B3. In step S2, it is determined whether the user has entered character strings into the title input area 21, the subtitle input area 22, the text input area 23, and the organization name input area 24 shown in FIG. 2. In this description, it will be assumed that the title and the subtitle are entered.

In step S3, the number of images entered into the user image input area 25 by the user is obtained. In step S4, based on the title, the subtitle, and the information (4 in this example) on the number of images, obtained in step S3, corresponding basic layout design templates are extracted from a basic layout design database installed in the system. The basic layout design templates are templates used for automatic production of layout designs, and the basic layout design database is a database storing therein a number of basic layout design templates. The details of them will be described later. In the first exemplary embodiment, it will be assumed that eight design templates that satisfy the conditions are extracted.

The basic layout design database is a database that is installed at the time of installing the application and stores therein a series of pre-designed basic layout design templates for a combination of the presence/absence of entered information in the four kinds of text input areas and the number of different images.

In step S5, the character strings and images entered by the user are applied to each of a plurality of basic layout design templates extracted in step S4. The designs produced in this way are saved as temporary files in a temporary directory within the system. FIG. 3 illustrates the examples of design layouts in which “Title,” “Subtitle,” and the four images are applied to the eight extracted basic layout design templates.

In step S6, the thumbnail images of the basic layout designs produced in step S5 are generated and saved as temporary files in the system. In step S7, it is determined whether the processing for all extracted basic design templates extracted in step S4 has been completed. If there is any basic design template which has not been processed, the flow returns to step S5 and the next basic design template is processed.

When it is determined in step S7 that the processing for all extracted basic design templates has been completed, the flow proceeds to step S8 and the thumbnail images of the plurality of produced basic layout designs are displayed on the basic layout design group display screen 30 as illustrated in FIG. 3.

On this screen, as described above, the user selects the thumbnail of the design at the left-bottom corner, for example, and instructs to produce fine-adjustment layout designs which are the derived designs produced from the basic layout design.

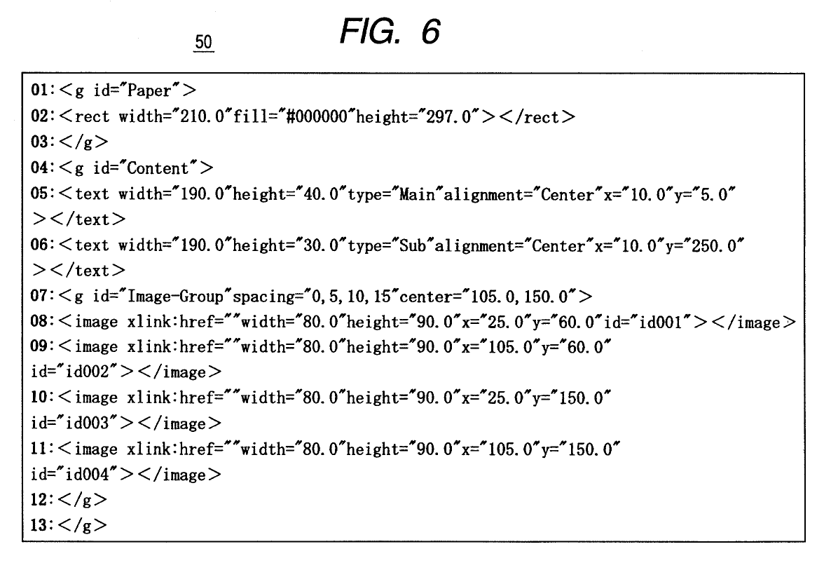

FIG. 6 is a schematic view of an example of a file structure 50 of the basic layout design selected in step S8. Similar to the above-described design templates (templates comprised of completed designs containing characters and images), the basic layout designs are layout designs produced by the designers. The layout designs are described by the file structure 50 so that the layout designs produced by the designers can be used by the application. The layout designs described in the format of the file structure 50 are referred to as basic layout design templates. The database storing the files of the respective basic layout design templates is referred to as the basic layout design database.

The file structure 50 of the basic layout design describes on line 02 that the basic layout design template is designed in a basic size with a width of 210 mm and a height of 297 mm.

The file structure 50 of the basic layout design defines the title and subtitle input areas on lines 05 and 06, respectively. Specifically, the input areas are identified by their “type” attributes, i.e., whether they are “Main” or “Sub.”

Although the file structure 50 shown in FIG. 6 does not have any definition for the text and organization name input areas, this is because the text and the organization name were not entered, and accordingly, the basic layout design template without such definitions was retrieved and extracted. If the user had entered the text and the organization name, a template having corresponding text input areas would be extracted from the basic layout design database.

Lines 07 to 12 of the file structure 50 of the basic layout design are delimited by “g” tags, indicating that they belong to one group. Lines 08 to 11 of the file structure 50 of the basic layout design correspond to the respective image areas and describe a layout including four image areas assembled at the center of the page, each of the image areas having a width of 80 mm and a height of 90 mm. These image areas are assigned to images by the order entered by the user, which are identified by their “id” attributes.

Parameters for automatically producing fine-adjustment layout designs are embedded in the basic layout design template. In this exemplary embodiment, the distance between the images arranged on the basic layout design template will be referred to as spacing. In the basic layout design template, derived designs with changed spacing are embedded in advance as the fine-adjustment layout designs. In the file structure 50, spacing=“0,5,10,15” on line 07 is the parameter for producing the fine-adjustment layout designs in which the image spacing is changed. This information describes at which spacing there are arranged the group of images delimited by the group tags, namely in this example, the respective entered images 1 to 4. The default spacing is 0, which means that the four images are arranged in close contact.

The information also says that designs with spacing of 5 mm, 10 mm, and 15 mm are respectively producible as the fine-adjustment layout designs. Other fine-adjustment layout designs than those layout designs with the modified spacing may be produced. Examples of such layout designs include a layout design in which the diagonal length of the image frame is changed without changing the central position and the aspect ratio of the image frame, or a layout design in which the position of the image frame relative to the whole design in a vertical direction is changed. In this case, the diagonal length and an amount of the shift, i.e. the length in mm, from the position of the image frame of the basic layout design in the vertical direction are used as the parameters. The values of these parameters or the range of the values are embedded in advance in the basic layout design. Although FIG. 6 illustrates the exemplary embodiment where the spacing is modified, in addition to the spacing, the derived designs may be produced by applying different shading effects to characters or images of a title, thereby producing different designs. Since the design elements that produce the derived designs are not limited to the arrangement (layouts) as described above, the meaning of the fine-adjustment layout design used in this exemplary embodiment includes the derived designs in which elements other than the layout are changed and the fine-adjustment layout design can be expressed as a derived design pattern (derived pattern). In many cases, the derived design is obtained by modifying a part of the basic layout design.

Next, the processing flow when the Fine-Adjust button 33 shown in FIG. 3 is pressed for the basic layout design selected by the user will be described.

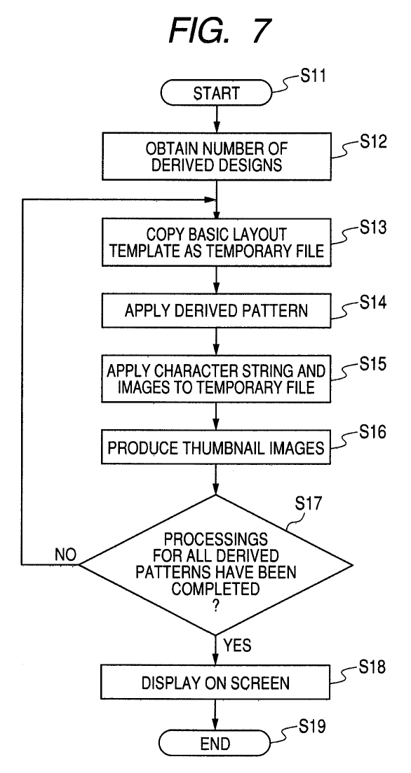

FIG. 7 illustrates the processing flow when the Fine-Adjust button 33 shown in FIG. 3 is pressed for the basic layout design selected by the user.

Step S11 indicates that a process of producing the fine-adjustment layout designs is started and it corresponds to a case where the Fine-Adjust button 33 in FIG. 3 is pressed.

In step S12, the number of producible fine-adjustment layout designs is obtained by analyzing the parameters described in the basic layout design template file selected by the user. By describing parameters for producing the fine-adjustment layout designs according to predetermined rules, the number of derived designs can be obtained, for example, by performing keyword search using “spacing” and counting the number of elements retrieved by the keyword “spacing.”

In step S13, the basic layout design template files are copied as temporary files. Thereafter, processing is performed on the files.

In step S14, the parameters for the spacing described on line 07 of the file structure 50 are applied to produce fine-adjustment layout designs. The first spacing is described as 0 on line 07; if the spacing is 0, no change is made from the basic layout design template.

In step S15, the character strings and images entered by the user are applied to the temporary file under processing. In step S16, a thumbnail file for screen display is produced as a temporary file.

In step S17, it is determined whether all the fine-adjustment layout designs have been produced. This determination is made by determining whether the fine-adjustment layout designs have been produced by the number obtained in step S12.

If it is determined in step S17 that the number of produced fine-adjustment layout designs is smaller than the number obtained in step S12, the flow returns to step S13 and next fine-adjustment layout designs are automatically produced. On the other hand, if it is determined in step S17 that the number of produced fine-adjustment layout designs has reached the number obtained in step S12, the flow proceeds to step S18. If only the fine-adjustment layout design with the spacing of 0 is produced, since the number of produced fine-adjustment layout design is 1 whereas the number obtained in step S12 is 4, the flow returns to step S13.

When the flow returns from step S17 to step S13, a new basic layout design template is copied and a temporary work file is produced in step S13. The flow proceeds again to step S14, to apply the value of the parameter for producing the next fine-adjustment layout design. In this step, the spacing of the image group is changed to 5 mm. On line 07 of the file structure 50 of the basic layout design template, the coordinate of the central point of the image group is described as (105.0, 150.0), so that the positions of the respective images are outwardly moved by 2.5 mm from that position.

Thereafter, in steps S15 and 16, the character strings and images entered by the user are applied to the temporary file under processing, thereby producing a thumbnail file. Then, the flow proceeds to step S17.

The operations of steps S13 to S17 are repeated until it is determined in step S17 that the number of produced fine-adjustment layout designs has become identical to the number obtained in step S12. In the case of the example shown in FIG. 6, since the number of fine-adjustment layout designs is determined as 4, four fine-adjustment layout design patterns in which the variations on the spacing (image spacing) are applied are produced. In step S18, a plurality of produced fine-adjustment layout designs is displayed on the fine-adjustment layout design display screen 40 as the candidates the user can select from. Similar to other screens, the thumbnails of the fine-adjustment layout designs are produced and displayed on this screen. Then, the user can select, as a final design, any one of the thumbnails of the fine-adjustment layout design candidates displayed on the fine-adjustment layout design display screen 40.

According to the known applications, all the designs that can be automatically produced are displayed in a list form at the same time. To the contrary, according to this exemplary embodiment, a plurality of basic layout designs that is automatically produced using the basic layout design template is displayed. Therefore, the users can select a design that matches their preference from a plurality of designs that give different impressions. Moreover, a plurality of fine-adjustment layout designs obtained by modifying a part of the selected basic layout design are automatically produced and displayed. Therefore, the users can select one from the fine-adjustment layout designs by comparing between a plurality of designs giving similar impressions as the basic layout design that matches their preference. Thus, the preferred design can be selected without difficulty.

The following derived design production methods may be employed. When characters (character data) or graphics (vector data) are contained in the page design, the derived design may be produced by changing the color of the characters or the graphics. The derived design may be produced by changing the trimming position of photos or images (raster data). Although an image is generally trimmed at the center thereof, since in some cases, a photographic subject or a characteristic portion in an image is located to be slightly shifted from the center in either the vertical or the horizontal direction, the optimum design can be obtained by performing the trimming with the parameter set so that the trimming position is shifted from the center. Moreover, the impression can change depending on whether or not image correction such as sharpness correction is applied to photos or images (raster data) or on the degree of the image correction, the derived design may be produced by changing the presence/absence of the correction processing to the photos or images (raster data). Furthermore, in addition to the image spacing, when the derived design is produced by changing the arrangement of objects (raster data, vector data or character data), if the arrangement position information of the respective objects of the basic layout design template as parameters for changing the position within a predetermined range is described to describe how much distance in mm as a unit the position will be changed, the derived design can be produced in which the arrangement of the objects is modified, without being limited to the images. Furthermore, the derived design may be produced by modifying the size information of the objects (raster data, vector data or character data). In this case, the derived design can be produced by changing the vertical and horizontal lengths of raster data such as photos or images, the font size of text data such as characters, or the coordinates of the points describing the lines of graphics of vector data, according to a size-change scaling. In addition, different impressions can be achieved depending on the rotation angle or the presence/absence of inversion processing to the raster data, the vector data, or the character data. Therefore, the derived design may be produced by describing the rotation information (rotation angle) or the inversion information (the presence/absence of the inversion processing) of the objects of the raster data, the vector data or the character data as the parameter for producing the derived design of the basic layout design template so that the rotation angle or the presence/absence of the inversion processing can be modified.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-167860, filed on Jun. 26, 2008, which is hereby incorporated by reference herein its entirety.

What is claimed is:

1. A design editing apparatus capable of editing designs, comprising:
a display unit that displays an editing screen for editing designs;
an operation unit through which operations input by a user are received;
an input unit that inputs characters or images based on the user operations input via the operation unit; and
a storage unit that stores therein templates describing a file structure for generating basic designs and derived designs regarding the basic designs; and
a design generation unit that generates basic designs using the templates stored in the storage unit and the characters or images input from the input unit to be displayed on the display unit, and generates a derived design regarding the basic design selected by the user via the operation unit from the displayed basic designs using the templates stored in the storage unit and the characters or images input from the input unit to be displayed on the display unit, thereby displaying the derived design selected by the user via the operation unit on the editing screen.

2. The design editing apparatus according to claim 1, wherein the design generation unit generates the derived design by modifying parameters described in the template of the selected basic design.

3. The design editing apparatus according to claim 1, wherein the design generation unit generates the derived design by applying a decorative effect to objects used for the design.

4. The design editing apparatus according to claim 1, wherein the design generation unit generates the derived design by modifying the color of vector data or text data.

5. The design editing apparatus according to claim 1, wherein the design generation unit generates the derived design by changing the trimming position for raster data.

6. The design editing apparatus according to claim 1, wherein the design generation unit generates the derived design by modifying the presence/absence of image correction processing for raster data or the degree of the correction.

7. The design editing apparatus according to claim 1, wherein the design generation unit generates the derived design by modifying the position information of raster data, vector data, or text data.

8. The design editing apparatus according to claim 1, wherein the design generation unit generates the derived design by modifying the size information of raster data, vector data, or text data.

9. The design editing apparatus according to claim 1, wherein the design generation unit modifies the rotation information or the inversion information for raster data, vector data, or text data.

10. A design editing method for editing designs, comprising the steps of:
displaying an editing screen for editing designs;
receiving operations input by a user;
inputting characters or images based on the user's operations; and
generating and displaying basic designs using templates extracted from a template database, the templates being created and stored in advance and capable of describing a file structure for generating basic design and derived designs regarding the basic designs, and the characters or images input in the inputting step, and generating and displaying a derived design regarding the basic design selected by the user in the receiving step from the displayed basic designs using the templates and the characters or images input in the inputting step, thereby displaying the derived design selected by the user in the receiving step on the editing screen.

11. The design editing method according to claim 10, wherein the generating and displaying step generates the derived design by modifying parameters described in the template of the selected basic design.

12. A storage medium storing therein a design editing program for editing designs, the program causing a computer to execute the steps of:
displaying an editing screen for editing designs;
receiving operations input by a user;
inputting characters or images based on the user's operations; and
generating and displaying basic designs using templates extracted from a template database, the templates being created and stored in advance and capable of describing a file structure for generating basic design and derived designs regarding the basic designs, and the characters or images input in the inputting step, and generating and displaying a derived design regarding the basic design selected by the user in the receiving step from the displayed basic designs using the templates and the characters or images input in the inputting step, thereby displaying the derived design selected by the user in the receiving step on the editing screen.

13. The storage medium according to claim 12, wherein the generating and displaying step generates the derived design by modifying parameters described in the template of the selected basic design.
